(19) United States
(12) Patent Application Publication
(10) Pub. No.: US 2006/0120402 A1
(43) Pub. Date: Jun. 8, 2006

(54) Method for running an X.25-based application on a second protocol-based network

(76) Inventor: Paul Gallant, Deux-Montagnes (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/005,295

(22) Filed: Dec. 7, 2004

(51) Int. Cl. H04L 12/56; H04J 3/16

(52) U.S. Cl. 370/466; 370/389

(57) ABSTRACT

A method is disclosed for enabling an application communicating using a first communication protocol to communicate with a physical network interface communicating using a second communication protocol wherein a driver is installed for providing a virtual first communication protocol interface card.

### CROSS-REFERENCE TO RELATED APPLICATIONS

This is the first application filed for the present invention.

### TECHNICAL FIELD

The present invention relates to the field of networking. More precisely, this invention pertains to the field of network interface cards.

### BACKGROUND OF THE INVENTION

Despite its age, the legacy X.25 communication protocol is still used with a large amount of applications around the world. For instance, various banking and telecommunication applications still use X.25-based applications.

Now referring to FIG. 1, there is shown a prior art embodiment where an X.25 communication protocol is used. In this embodiment, a first host 8 communicates with a second host 16 via an X.25 network 14.

More precisely, the first host 8 comprises a first processing unit 10 running an X.25 application and an X.25 interface 12. The X.25 application may be any type of applications. The X.25 interface 12 is adapted to connect the first processing unit 10 running an X.25 application to the X.25 network 14.

The second host 16 comprises a second processing unit 20 running an X.25 application and an X.25 interface 18. The X.25 application running on the second processing unit 20 may be any type of X.25 application. The X.25 interface 18 is adapted to connect the second processing unit running an X.25 application 20 to the X.25 network 14.

Unfortunately, the cost of setting up data networks operating with the X.25 communication protocol is quite expensive in comparison to the cost for setting up data networks operating with other data packet protocols. Various solutions have been implemented for addressing this cost issue. For example a TCP/IP network may be used to transmit data packets.

The use of X.25 over TCP/IP, also known as XOT, tries to addresses this issue. Unfortunately using XOT leads to various drawbacks. For instance, it is known by the skilled addressee that TCP, which is used on XOT, requires an overhead for signaling. Furthermore, XOT is usually implemented on a dedicated network device (X.25 to IP gateway) which therefore requires extra hardware.

There is therefore a need for a method and apparatus that will overcome at least one of the above-identified drawbacks.

### SUMMARY OF THE INVENTION

In one of its aspects, the invention provides a method for enabling an application communicating using a first communication protocol to communicate with a physical network interface communicating using a second communication protocol.

In another aspect, the invention provides a method for enabling an X.25 application to communicate over a non-X.25 data packet using a corresponding non-X.25 interface.

According to an embodiment of the invention, there is provided a method for enabling an application that uses a first communication protocol to communicate with a physical network interface that uses a second communication protocol, the method comprising providing a driver for simulating another network interface communicating with the first communication protocol, receiving a data packet from one of the application and the physical network interface, if the data packet is received from the application, using the driver to encapsulate the data packet according to the second communication protocol and providing the encapsulated data packet to the physical network interface and if the data packet is received from the network interface, decapsulating the data packet to provide a data packet suitable with the first communication protocol and providing the decapsulated data packet to the application using the driver.

According to another embodiment of the invention, there is provided a driver for enabling an application that uses a first communication protocol to communicate with a physical network interface that uses a second communication protocol, the method comprising a software implemented network interface card simulating a network interface card for the application operating according to the first communication protocol and an encapsulating/decapsulating unit encapsulating a first given received packet from the software implemented network interface card according to the second communication protocol and providing the encapsulated packet to the physical network interface; the encapsulating/decapsulating unit further decapsulating a second given received packet from the physical network interface according to the first communication protocol to provide a decapsulated packet and further providing the decapsulated packet to the application.

### BRIEF DESCRIPTION OF THE DRAWINGS

Further features and advantages of the present invention will become apparent from the following detailed description, taken in combination with the appended drawings, in which:

FIG. 1 is a block diagram showing a prior art embodiment where a first host comprising a first processing unit running an X.25 application communicates with a second host comprising a second processing unit running another X.25 application using an X.25 network;

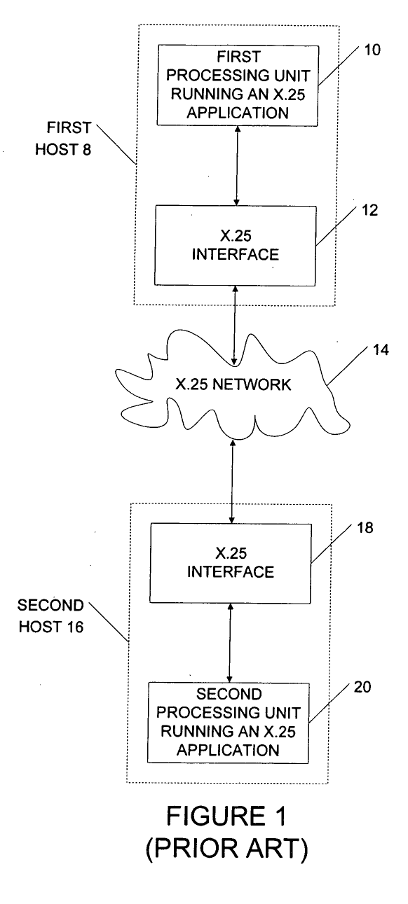

FIG. 2 is a block diagram showing an embodiment of the invention in a system where a first host comprising a first processing unit running an X.25 application communicates with a second host comprising a second processing unit running an X.25 application and a third host comprising a third processing unit running an X.25 application;

FIG. 3 is a flowchart showing a method for inter-protocol communication according to an embodiment of the invention;

FIG. 4 is a flowchart showing a method for inter-protocol communication according to another embodiment of the invention where a data packet is received either from an X.25 application or from a TCP/IP physical network interface; and

FIG. 5 is a block diagram showing an embodiment of the invention where a host running an X.25 application communicates with another X.25 application over a TCP/IP network.

It will be noted that throughout the appended drawings, like features are identified by like reference numerals.

### DETAILED DESCRIPTION OF THE PREFERRED EMBODIMENT

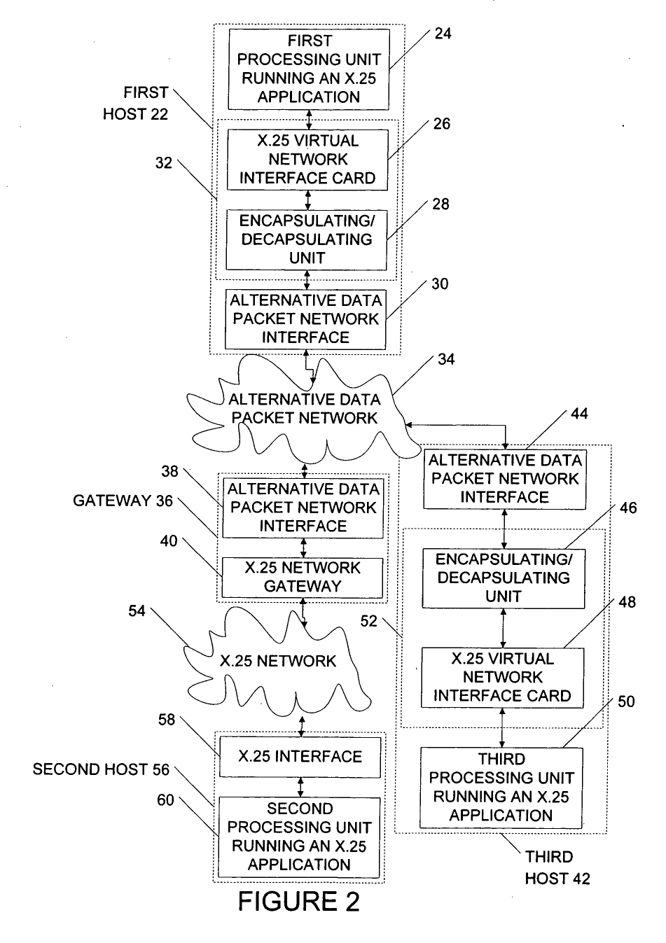

Now referring to FIG. 2, there is shown an embodiment where a first host 22 communicates with a second host 56 and with a third host 42.

More precisely, the first host 22 communicates with the second host 56 via an alternative data packet network 34, a gateway 36 and an X.25 network 54.

The first host 22 also communicates with the third host 42 via the alternative data packet network 34.

The alternative data packet network 34 may comprise any type of data packet network such as a Local Area Network (LAN), a Metropolitan Area Network (MAN), a Wide Area Network (WAN) or the like. The data packet network 34 may further operate using any type of communication protocol outside of the X.25 protocol. Preferably, the alternative data packet network 34 is a Wide Area Network operating according to the TCP/IP communication protocol, such as the Internet.

More precisely, the first host 22 comprises a first processing unit running an X.25 application 24, a driver 32 and an alternative data packet network interface 30. The driver 32 comprises an X.25 virtual network interface card 26 and an encapsulating/decapsulating unit 28.

The first processing unit running an X.25 application 24 may be any type of processing unit. In a preferred embodiment, the first processing unit comprises a Linux based system running a X.25 socket based application.

The alternative data packet network interface 30 may be any type of network interface adapted for communicating with the alternative data packet network 34. In a preferred embodiment, the alternative data packet network interface 30 comprises an Ethernet interface using TCP/IP protocol stack.

As mentioned earlier, the driver 32 comprises an X.25 virtual network interface card 26 (software implemented network interface card) and an encapsulating/decapsulating unit 28. The driver 32 is preferably installed in the volatile memory of the first host 22.

In fact, the X.25 virtual network interface card 26 of the driver 32 may be a software module which is intended to simulate the presence of a X.25 network interface in the operating system of the first host 22.

The encapsulating/decapsulating unit 28 of the driver 32 may be a software module which is intended to encapsulate data packets originating from the X.25 application into encapsulated data packets which are suitable to be transmitted on the alternative data packet network. It should be understood by the skilled addressee that the encapsulating comprises performing any ISO Layer 2 operations that are required for transmitting the data packet over the alternative data packet network 34. On the X.25 virtual network interface card 26 side, the virtual interface provides support for X.25 sockets APIs for end-user applications to be able to make use of it. On the alternative data packet network interface 30 side, means are provided to configure destination address and other parameters (such windowing) for a given connection. It also comprises proper translation of X.25 SVC and PVC sessions into the alternate data packet session format (such as for example XOT).

Furthermore, the encapsulating/decapsulating unit 28 of the driver 32 is intended to decapsulate data packets received from the alternative data packet network interface 30 into data packets that are suitable to be used by the X.25 application.

The gateway 36 is adapted for bridging traffic between the alternative data packet network 34 and the X.25 network 54. In this embodiment the gateway 36 comprises an alternative data packet network interface 38 which is connected to the alternative data packet network 34 and a X.25 network gateway 40 connected to the X.25 network 54 and further to the alternative data packet network interface 38. The skilled addressee will appreciate that the gateway 36 may be provided according to various parameters such as bandwidth, security requirements or the like. In a preferred embodiment, the gateway 36 comprises an Eicon 1550 WAN Router.

The second host 56 comprises a X.25 interface 58 and a second processing unit running an X.25 application 60. The second processing unit running an X.25 application 60 is connected to the X.25 network 54 using the X.25 interface 58. The skilled addressee will appreciate that the X.25 interface 58 may be selected according to various parameters such as bandwidth, security requirements, guaranteed delivery, reliability and latency. In a preferred embodiment, the X.25 interface 58 comprises an Eiconcard S91.

The third host 42 is connected to the alternative data packet network 34.

The third host 42 comprises an alternative data packet network interface 44, a driver 52 and a third processing unit running an X.25 application 50.

More precisely, the alternative data packet network interface 44 may be any type of network interface adapted for communicating with the alternative data packet network 34. In a preferred embodiment, the alternative data packet network interface 44 comprises an Ethernet interface using TCP/IP protocol stack.

The driver 52 comprises an encapsulating/decapsulating unit 46 and an X.25 virtual network interface card 48.

Similarly to the encapsulating/decapsulating unit 28 of the driver 32, the encapsulating/decapsulating unit 46 is a software module which is intended to encapsulate data packets originating from the X.25 application into encapsulated data packets which are suitable to be transmitted on the alternative data packet network 34. Again, it should be understood by the skilled addressee that the encapsulating comprises performing any ISO Layer 2 operations that are required for transmitting the data packet over the alternative data packet network 34.

Furthermore, the encapsulating/decapsulating unit 46 of the driver 52 is intended to decapsulate data packets received from the alternative data packet network interface 44 into data packets that are suitable to be used by the X.25 application.

The X.25 virtual network interface card 48 of the driver 52 is a software module which is intended to simulate the presence of a X.25 network interface in the operating system of the third host 42. The virtual interface network card 48 provides support for X.25 sockets and Eicon ECNCB (Eicon X.25 Toolkit) APIs for end-user applications to be able to make use of it.

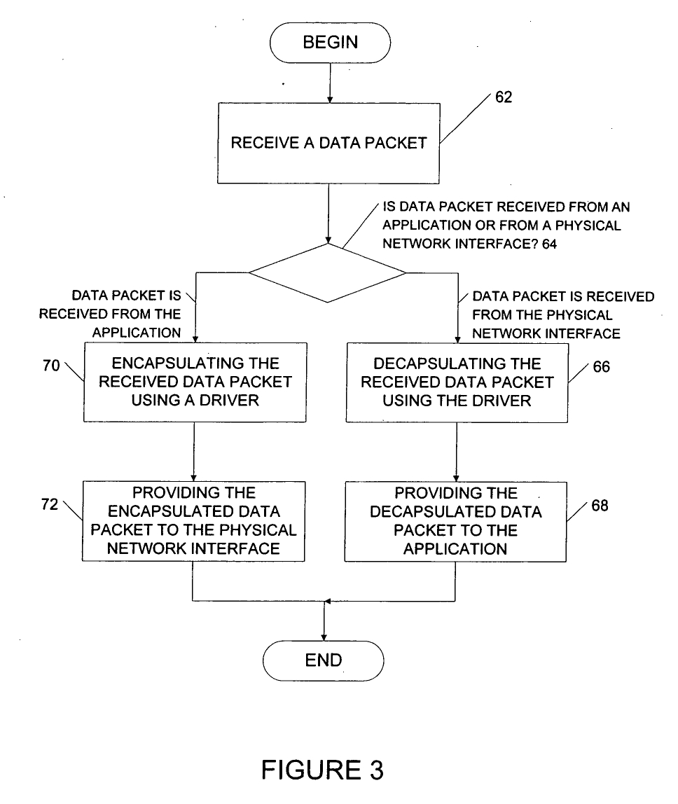

Now referring to FIG. 3, there is shown a first embodiment of the operation of a driver (such as 32 or 52 from FIG. 2). In this embodiment, a host is running a network application functioning according to a first given data packet protocol. The host is connected to a network operating according to a second given data packet protocol using a physical network interface.

According to step 62, a data packet is received by the driver.

According to step 64, a test is performed in order to find out if the data packet is received from the application or from the physical network interface.

In the case where the data packet is received from the application and according to step 70, the received data packet is encapsulated using an encapsulation/decapsulation unit comprised in the driver according to the second given protocol to be used in the data network.

According to step 72, the encapsulated data packet is provided to a physical network interface. The physical network interface is adapted to transmit data to the data network. The data packet is then transmitted over the data network via the physical network interface.

In the case where the data packet is received from the network interface and according to step 66, the received data packet is decapsulated using the encapsulation/decapsulation unit of the driver. The data packet is decapsulated according to the first given protocol used by the application.

According to step 68, the decapsulated data packet is provided to the application.

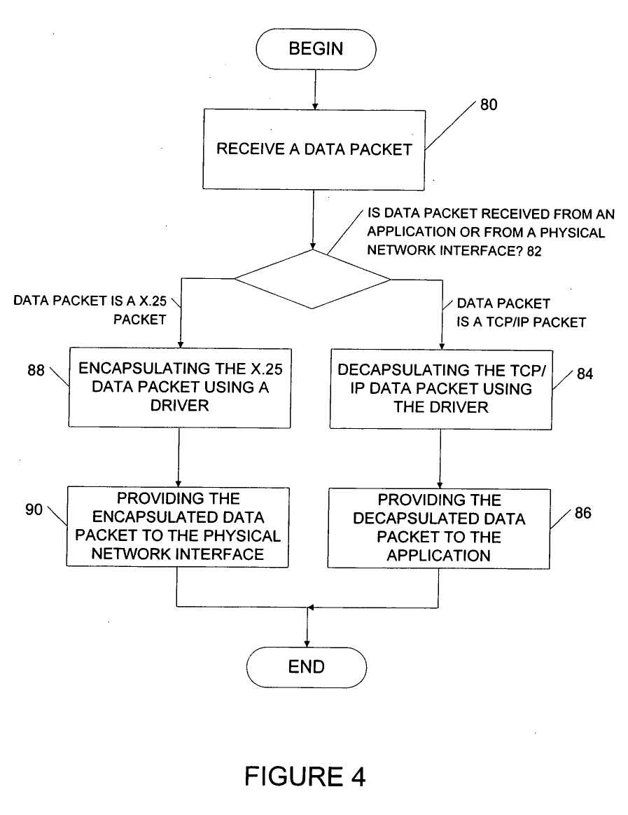

Now referring to FIG. 4, there is shown another embodiment where a host, running an X.25 application, is connected to a TCP/IP network using a TCP/IP network interface.

According to step 80, a data packet is received.

According to step 82, a test is performed in order to find out if the data packet is an X.25 packet or a TCP/IP packet. If the data packet is coming from the X.25 virtual network interface card, it is treated as a X.25 packet and, consequently it is encapsulated and forwarded via the TCP/IP session to the remote site. If the packet is coming from a real interface through the system IP stack with the system's destination IP address and port, the packet is decapsulated and forwarded to the application via the virtual NIC.

In fact, in the case where the data packet is a TCP/IP data packet and according to step 84, the TCP/IP data packet is decapsulated in a data packet. The decapsulated data packet comprises a X.25 data packet.

According to step 86, the X.25 data packet is provided to the X.25 application.

Furthermore, in the case where the data packet is an X.25 data packet and according to step 88, the TCP/IP data packet is encapsulated in a data packet. The encapsulated data packet comprises a TCP/IP data packet.

According to step 90, the encapsulated data packet is provided to the TCP/IP network interface.

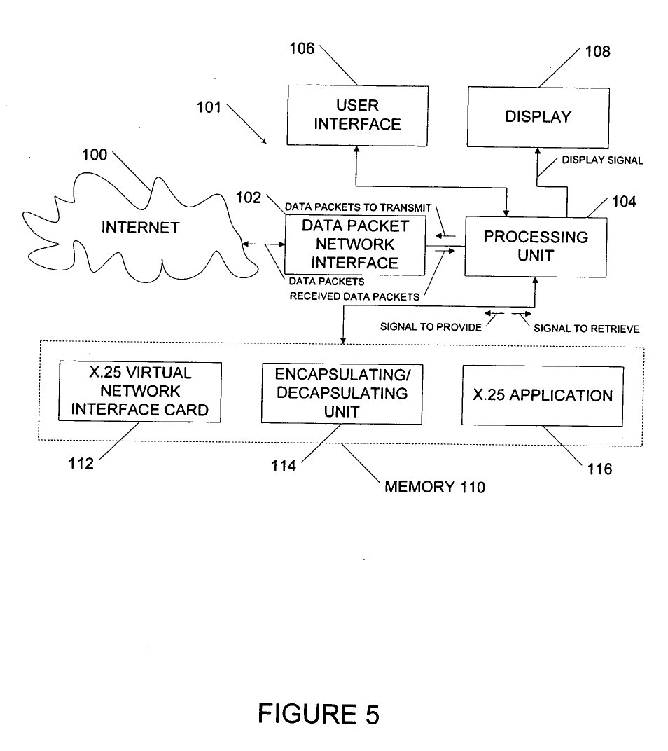

Now referring to FIG. 5, there is shown an example of a host 101 running an X.25 application and communicating with another X.25 application over a TCP/IP network which is the Internet 100.

The host 101 comprises a user interface 106, a display unit 108, a data packet network interface 102, a processing unit 104 and a memory 110.

The memory 110 comprises a driver comprising an X.25 virtual network interface card 112 and an encapsulating/decapsulating unit 114, and an X.25 application 116. The memory is connected to the processing unit 104. More precisely, the processing unit 104 provides a signal to the memory 110 and receives a signal to retrieve from the memory 110.

The user interface 106 is adapted to provide an interface to an operator of the host 101. The user interface 106 is connected to the processing unit 104 of the host 101. The user interface 106 may be at least one of a mouse, a keyboard or the like. Preferably, the user interface comprises a keyboard and a mouse. It should be appreciated that such system, depending on the end-user application may work in unattended mode without any user interface.

The display 108 is adapted to display a visual signal to an operator of the host 101. The display receives a display signal which is provided by the processing unit 104. The display 108 may be anyone of a CRT display, a plasma display or the like. In the preferred embodiment, the display 108 comprises a Cathode Ray Tube (CRT) display. It should be appreciated that such system, depending on the end-user application may work in unattended mode without any user interface.

The data packet network interface 102 is a physical network interface adapted for providing a network connection to the host 101. The data packet network interface 102 receives a data packet to transmit from the processing unit 104 and provides at least one data packet to the internet 100. The data packet network interface 102 further receives data packets from the internet 100 and provides a received data packet to the processing unit 104. In the preferred embodiment, the data packet network interface 102 comprises an Ethernet interface using TCP/IP protocol stack.

The processing unit 104 is adapted for processing data according to the embodiment disclosed in FIG. 4.

It will be appreciated that the embodiment disclosed in FIG. 5 is of great advantage as it enables the application to access the Internet without requiring a physical X.25 network interface. Furthermore, it will be appreciated that the X.25 virtual network interface card 112 and the encapsulating/decapsulating unit 114 may be installed at once or when desired.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetic signal.

The embodiments of the invention described above are intended to be exemplary only. The scope of the invention is therefore intended to be limited solely by the scope of the appended claims.

We claim:

1. A method for enabling an application that uses a first communication protocol to communicate with a physical network interface that uses a second communication protocol, said method comprising:
providing a driver for simulating another network interface communicating with said first communication protocol;
receiving a data packet from one of said application and said physical network interface;
if said data packet is received from said application, using the driver to encapsulate said data packet according to said second communication protocol and providing said encapsulated data packet to said physical network interface; and
if said data packet is received from said network interface, decapsulating said data packet to provide a data packet suitable with said first communication protocol and providing said decapsulated data packet to said application using said driver.

2. The method as claimed in claim 1, wherein said first communication protocol comprises X.25.

3. The method as claimed in claim 2, wherein said second communication protocol comprises TCP/IP.

4. The method as claimed in claim 3, further comprising providing said encapsulated packet via said physical network interface to at least one of a Wide Area Network (WAN), a Metropolitan Area Network (MAN) and a Local Area Network (LAN).

5. The method as claimed in claim 4, wherein said Wide Area Network comprises the Internet.

6. The method as claimed in claim 1, wherein said driver is provided from at least one of a remote location and a local location.

7. A driver for enabling an application that uses a first communication protocol to communicate with a physical network interface that uses a second communication protocol, said method comprising:
a software implemented network interface card simulating a network interface card for said application operating according to said first communication protocol; and
an encapsulating/decapsulating unit encapsulating a first given received packet from said software implemented network interface card according to said second communication protocol and providing said encapsulated packet to said physical network interface; said encapsulating/decapsulating unit further decapsulating a second given received packet from said physical network interface according to said first communication protocol to provide a decapsulated packet and further providing said decapsulated packet to said application.

8. The driver as claimed in claim 7, wherein said first communication protocol comprises X.25.

9. The driver as claimed in claim 8, wherein said second communication protocol comprises TCP/IP.
